(19) United States
(12) Patent Application Publication
(10) Pub. No.: US 2026/0030642 A1
(43) Pub. Date: Jan. 29, 2026

(54) Product Authenticity Detection System and Method Utilizing Verified Serial Numbers

(71) Applicant: Ege Celengil, Los Angeles, CA (US)

(72) Inventor: Ege Celengil, Los Angeles, CA (US)

(21) Appl. No.: 19/276,952

(22) Filed: Jul. 22, 2025

Related U.S. Application Data
(60) Provisional application No. 63/674,711, filed on Jul. 23, 2024.

(51) Int. Cl. G06Q 30/018

(52) U.S. Cl. CPC G06Q 30/0185

(57) ABSTRACT

A product authentication detection system utilizing unique serial numbers applied to bills of currency, i.e. legal tender or the legal currency of various countries. This serial number is printed or engraved onto the product and paired/delivered with the original legal tender. The purchaser of the authenticated product is also provided with the bill of currency containing the unique serial number. Both the product and the legal tender are catalogued in digital and/or physical records. Product is authenticated by this method by checking a product authenticity database for a matching serial number.

### BACKGROUND OF THE INVENTION

The global garment industry faces significant challenges from the production of unauthorized replicas and counterfeit products. The proliferation of online resellers has exacerbated this issue in recent years. Existing solutions, such as QR codes, NFC tags, and RFID chips, are not foolproof, as these technologies can be easily duplicated by counterfeiters. Ironically, the inclusion of these security features on counterfeit products can make them appear more legitimate to consumers.

Furthermore, a common practice among manufacturers involves producing additional quantities of branded products without the brand owner's knowledge. For instance, a manufacturer may receive an order for 100 t-shirts but produce 200, selling the extra 100 through unauthorized channels. While counterfeiting clothing poses minimal direct risk to consumers, the same cannot be said for counterfeit pharmaceuticals, auto parts, and children's toys, which pose significant health and safety risks.

According to the 2023 Review of Notorious Markets for Counterfeiting and Piracy by the Office of the United States Trade Representative, counterfeit markets harm not only brand owners but also endanger consumers. Counterfeit products, produced outside regulatory frameworks and inspection systems, often use substandard materials and fail to meet safety standards, posing serious risks to unsuspecting consumers. The National Crime Prevention Council estimates that counterfeit products generate $2 trillion in annual sales.

The disclosed proposed solution aims to address this issue by significantly reducing the prevalence of counterfeit products and the associated financial and physical harms. Although initially conceived for the garment industry, this solution can be applied to any physical product.

### SUMMARY OF THE INVENTION

The present invention is designed to combat the manufacturing of counterfeit garments and other physical products and to establish an impenetrable authentication system utilizing the unique serial numbers applied to bills of currency, i.e. legal tender or the legal currency of various countries. Each legal tender, i.e. a specific bill of legal currency from a specific country, sourced from banks, possesses a distinctive serial number. For example, each bill of US currency, i.e. each one/two/five/ten/twenty/one hundred dollar bill, includes a unique serial number. Other legal currencies such as the Euro (European Union), Yen (Japan), Pound (United Kingdom), Swiss Franc (Switzerland), Canadian Dollar, Australian Dollar, and Yuan (China) include unique serial numbers on each bill. This serial number is printed or engraved onto the product and paired/delivered with the original legal tender. The purchaser of the authenticated product is also provided with the bill of currency containing the unique serial number. Both the product and the legal tender are catalogued in digital and/or physical records. Consumers purchasing a product authenticated by this method can verify its authenticity by checking our product authenticity database for a matching serial number.

The difficulty of successfully copying currency, coupled with the serious criminal penalties for doing so, are a significant advantage over more easily counterfeited NFC tags, radio frequency identification (RFID) chips, or QR Codes.

### BRIEF DESCRIPTION OF THE DRAWINGS

FIG. 1 is a representation of a bill of currency with serial number.

FIG. 2 shows an authenticated product with a serial number.

FIG. 3 is a first screen of an authentication database.

FIG. 4 is a second screen of an authentication database.

FIG. 5 is the first screen of the authentication database with a counterfeit serial number input on the screen.

FIG. 6 is an alternative second screen of an authentication database.

FIG. 7 is an alternative embodiment of the present invention with an unmarked authenticated product.

### DESCRIPTION OF THE PREFERRED EMBODIMENT

The following detailed description refers to the preferred embodiment of the disclosed invention as shown in the attached figures and in the below description. This detailed description is not meant to limit the scope of the invention in any way but is intended to disclose the preferred embodiment/best mode of the invention at the time of filing this application.

The present product authenticity detection system and method is comprised of three core components: 1) a single bill of legal tender currency with an imprinted unique serial number, 2) an authenticated product with the unique serial number of the bill of legal tender currency imprinted on the product, and 3) a database that matches the serial number of the bill of currency with the serial number imprinted on the authenticated product.

An essential core portion of the present invention is a single bill of legal tender currency from a reputable nation and produced by that nation's central bank. Examples of appropriate currency include the US Dollar, European Union Euro, British Pound, Japanese Yen, Swiss Franc, Australian Dollar, Canadian Dollar and Chinese Yuan. Each of these currencies are produced using multiple anti-counterfeiting technologies that make producing counterfeit bills that pass detection as fakes exceedingly difficult.

Each of these currencies are produced in various bill denominations. For example, common US Dollar denominations are one, two, five, ten, twenty and one hundred dollars. Each of the other example currencies have their own produced denominations. Each of these bills of currency is imprinted with a unique serial number. This unique serial number is utilized as the matching element for each product contained in the authenticity database. The specific currency details, i.e. the country and denomination, may be chosen by the manufacturer based on their specific preferences, as long as the currency is very difficult to counterfeit and each bill of the currency has a unique serial number. For purposes of this application, each specific bill of currency, with a unique serial number, will be referred to as a bill of currency or currency.

In addition to the difficulty of counterfeiting bills of currency, there are significant criminal penalties for attempts to do so. These substantial penalties, including significant prison time, are real additional deterrent to attempting to create fake bills to authenticate fake products. Using the already developed, extensive and expensive anti-counterfeiting techniques of national central banks makes defeating this system by producing fake bills of currency very difficult. In contrast, existing systems using QR codes, radio frequency identification (RFID) chips, or NFC tags are very easy to fake or defeat and thus do not effectively authenticate products as being legitimate.

Another essential core element of the present invention is a product to be authenticated utilizing a bill of currency. In this application, a clothing item is used as the product to be authenticated, but any product that might need unique certification as authentic could be utilized. Examples of such products include pharmaceuticals, precious metals, gemstones, leather goods, auto parts, toys, and software. Any product in need of authentication as real could be used with this system.

With this system, the unique serial number imprinted on the bill of currency is also printed on the item to be authenticated. This printed serial number is used, in conjunction with the bill of currency and the matching database, to provide authentication of the product.

Lastly, an authentication database matches the serial number from the bill of currency to the serial number imprinted on the product to be authenticated. This database may be implemented in software using tools and techniques well known in the art or may even be implemented in a physical paper-based register.

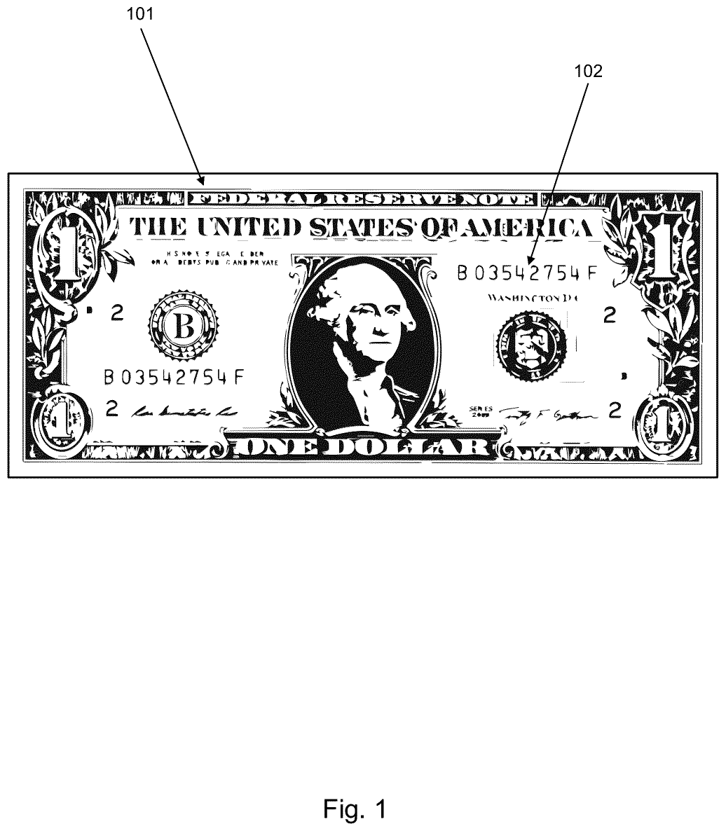

FIG. 1 shows a representation of a bill of currency 101 utilized in the present invention. In this example, bill of currency 101 is a US one dollar bill, but any suitable bill of currency, that meets the requirements outlined above, may be utilized. Bill of currency 101 includes serial number 102. This serial number 102 is unique to this bill of currency 101 and is utilized as a key to authenticate a specific product.

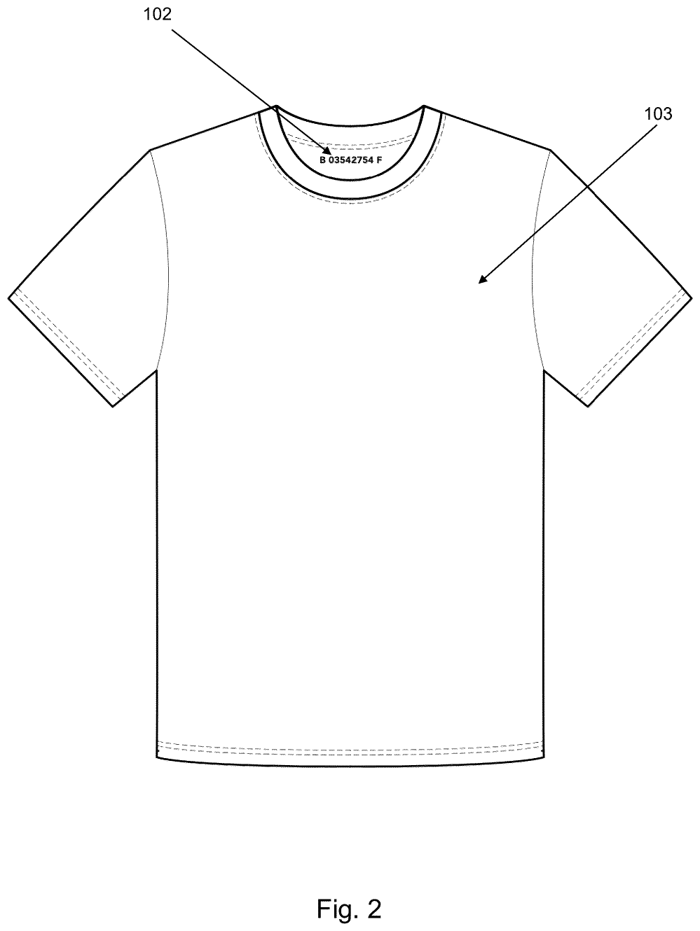

FIG. 2 shows an authenticated product 103, in this case a shirt. Printed on the interior of the shirt is serial number 102. Serial number 102 is the same serial number 102 as found on bill of currency 101. While a shirt is shown in this embodiment, any product needing verification as authentic may be used as an authenticated product 103. When a consumer purchases an authenticated product 103, they are also provided the bill of currency 101 with the serial number 102 that matches both the currency and the authenticated product 103. The authenticity of the authenticated product 103 may then be verified in the authentication database. The serial number 102 may be attached to authenticated product 103 using a variety of methods well known in the art. In the preferred embodiment, the serial number 102 is printed on the product 103, but it may also be etched, embroidered, and printed on a label attached to the product 103. Any suitable method well known in the art may be utilized.

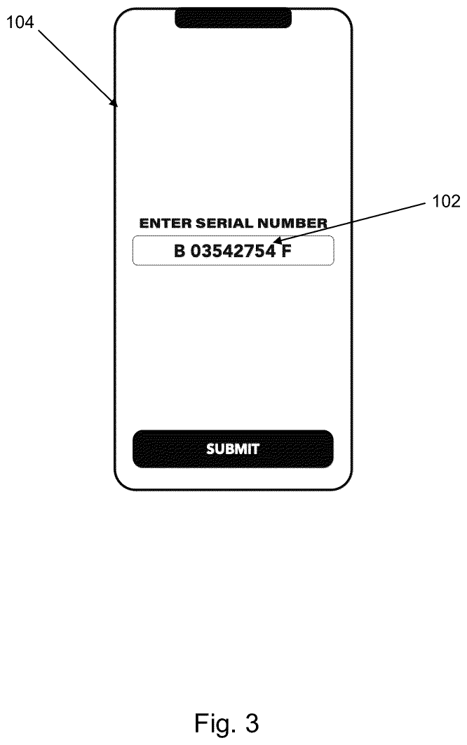

FIG. 3 shows a first screen of the authentication database 104. On this screen, the consumer inputs serial number 102 into authentication database 104 and presses the submit button to access the database. In the preferred embodiment, authentication database 104 is implemented as a web/internet tool/site that is accessed through a web browser such as Google Chrome®, Microsoft Edge®, Mozilla Firefox®, Apple Safari®, or any other internet/web browsing application well known in the art. Authentication database 104 may also be implemented as an application on a mobile phone such as an Apple iPhone® or a Google Android® mobile device. Authentication database 104 may be implemented utilizing any secure database technology well known in the art. The application containing the authentication database 104 may also be implemented using any secure application coding technology well known in the art. Both the database and application coding technologies must be sufficiently secure to deter hacking of the database.

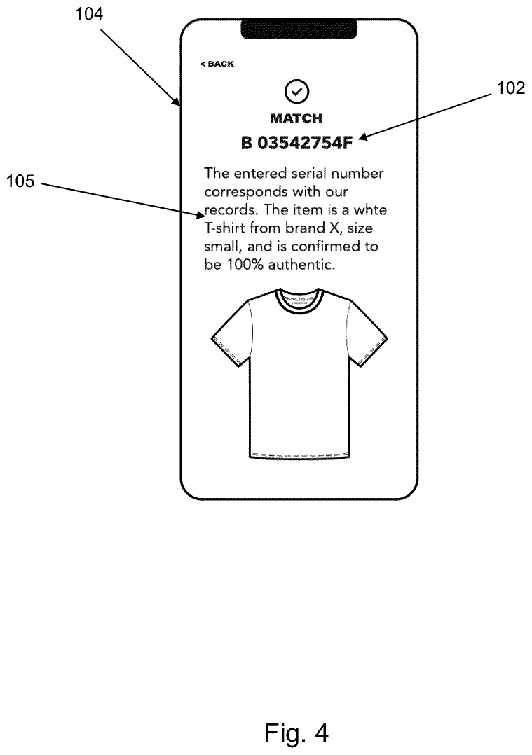

FIG. 4 shows a second screen of authentication database 104. In this screen, shown after the user presses the submit button on the screen of FIG. 3, the user is presented with an authentication match record 105. This authentication match record 105 shows that the serial number 102 from the bill of currency 101 and the authenticated product 103 match, and that the record is stored in the authentication database 104 indicates an authentic, verified product.

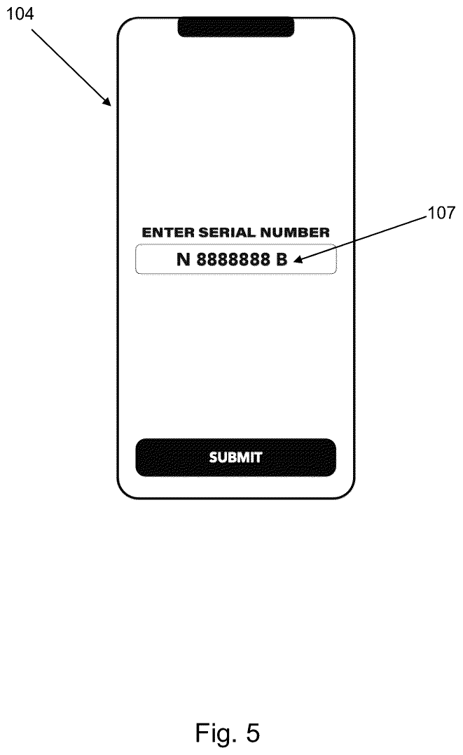

FIG. 5 shows a first screen of the authentication database 104 with a counterfeit serial number 107 input into authentication database 104. Counterfeit serial number 107 is not authenticated by a serial number 102 on a bill of currency 101. This indicates that the product with the associated counterfeit serial number 107 may be a fake, counterfeit or otherwise not authentic version of a branded product.

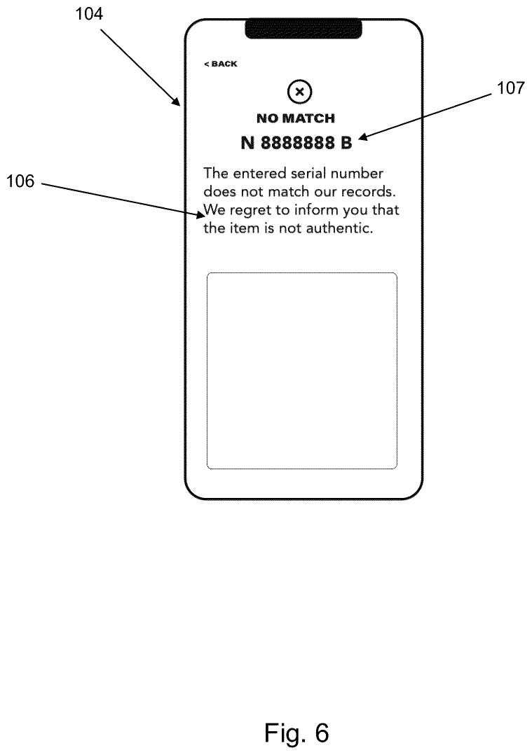

FIG. 6 shows an alternative second screen of authentication database 104. The displayed no match record 106 indicates that counterfeit serial number 107 is not contained in the authentication database 104. This no match record 106 indicates that the product associated with counterfeit serial number 107 is not authenticated as legitimate.

This embodiment of the system shows an authentication database 104 implemented via a mobile web browser page displayed on a mobile device. Other embodiments include implementation on a desktop/notebook computer, as a mobile application, on cloud-based computers/software as a service or even manually in a paper record. As long as the authentication database 104 cannot be hacked, tampered or duplicated, any method of implementation may be utilized.

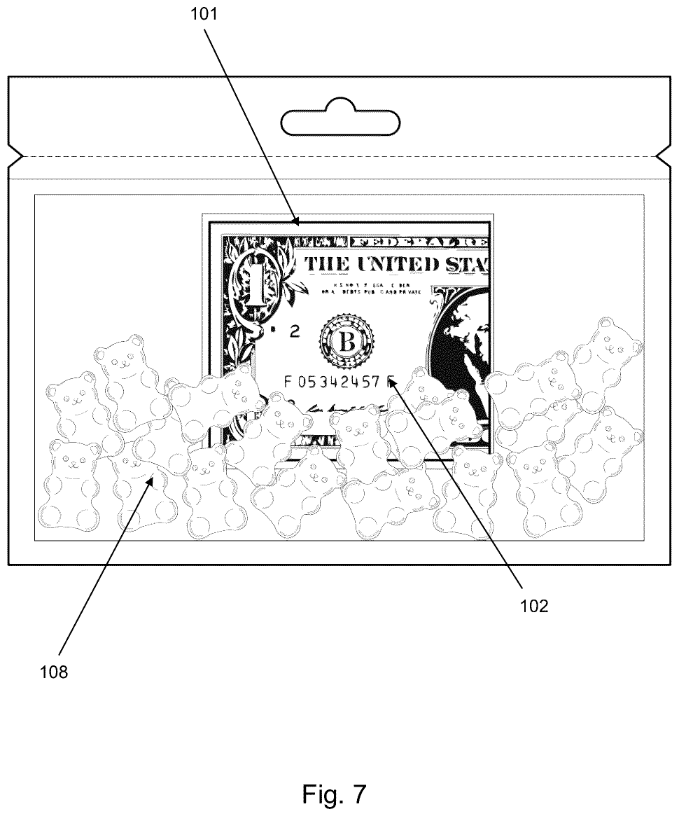

FIG. 7 shows an alternate embodiment of the present invention with an unmarked authenticated product 108. Some products are suited to being marked with a serial number 102 due to the nature of the product. Food products (such as the gummie bears shown in FIG. 7), pharmaceuticals, cannabis, and many other products cannot effectively be marked with the serial number 102 from a bill of currency 101. For these products, the bill of currency 101 may be sealed inside the packaging with the unmarked authenticated product 108. If the package remains sealed, the association between the unmarked authenticated product 108 and the serial number 102 is considered intact. This serial number 102 is input into authentication database 104 as with any other authenticated product 103. The authentication database will provide a match record 105 or a no match record 106 depending on the status of the serial number 102 in the authentication database 104.

While this embodiment of the invention is described in relation to FIGS. 1-7, it is possible to modify the sequence of the events or the method of implementation of the system in other embodiments. The only requirement is that the core components of a bill of currency 101, a serial number 102, an authenticated product 103 (or unmarked authenticated product 108), and an authentication database 104 must be present to implement the system.

Although the present invention has been described in relation to the above disclosed preferred embodiment, many modifications in design, implementation, systems and execution are possible while still maintaining the novel features and advantages of the invention. The preferred embodiment is not meant to limit the scope of the patent in any way, and it should be given the broadest possible interpretation consistent with the language of the disclosure on the whole.

1. A system for detecting product authenticity comprising:
a bill of legal tender currency where the bill includes a unique serial number;
a product for authentication, where the product comprises the unique serial number attached to the product; and
an authentication database comprising at least one product associated with one unique serial number.

2. The system of claim 1 where the bill of legal tender currency is selected from the group consisting of the US Dollar, European Union Euro, British Pound, Japanese Yen, Swiss Franc, Australian Dollar, Canadian Dollar and Chinese Yuan.

3. The system of claim 1 where the unique serial number is attached using a method selected from the group consisting of printing, embroidering, etching and labeling.

4. The system of claim 1 where the authentication database is stored on a computing device.

5. The system of claim 1 where the authentication database is stored on a written ledger.

6. The system of claim 4 where the authentication database is accessed through a computing network.

7. The system of claim 1 where the bill of legal tender currency is delivered with the product.

8. A system for detecting product authenticity comprising:
a bill of legal tender currency where the bill includes a unique serial number;
a product for authentication, where the product is delivered with the bill of legal tender currency; and
an authentication database comprising at least one product associated with one unique serial number.

9. The system of claim 8 where the bill of legal tender currency is selected from the group consisting of the US Dollar, European Union Euro, British Pound, Japanese Yen, Swiss Franc, Australian Dollar, Canadian Dollar and Chinese Yuan.

10. The system of claim 8 where the authentication database is stored on a computing device.

11. The system of claim 81 where the authentication database is stored on a written ledger.

12. The system of claim 10 where the authentication database is accessed through a computing network.
